(19) United States
(12) Patent Application Publication
(10) Pub. No.: US 2023/0292807 A1
(43) Pub. Date: Sep. 21, 2023

(54) NUTRITIONAL COMPOSITION WITH NATURAL INGREDIENTS AND METHOD OF PREPARATION THEREOF

(71) Applicant: STANDARD FOODS CORPORATION, Taipei City (TW)

(72) Inventors: Kai En Chuang, Taoyuan City (TW); Ann Feng, Taoyuan City (TW); Wen Hsieh Lo, Taoyuan City (TW); Jun Yi Wu, Taoyuan City (TW)

(21) Appl. No.: 18/184,691

(22) Filed: Mar. 16, 2023

Related U.S. Application Data
(60) Provisional application No. 63/269,545, filed on Mar. 18, 2022.

(51) Int. Cl. A23L 33/00; A23L 33/19; A23L 29/10

(52) U.S. Cl. CPC A23L 33/40; A23L 33/19; A23L 29/10

(57) ABSTRACT

Provided is a nutritional composition with natural ingredient, including natural ingredient, fat, carbohydrate, and protein, in which a viscosity of the nutritional composition is from 20 cPs to 1000 cPs. Provided also is a method of preparing nutritional composition with natural ingredient, so as to obtain a nutritional composition with the flavor of natural ingredients.

### CROSS-REFERENCE TO RELATED APPLICATION

This application claims priority to U.S. Provisional Application Ser. No. 63/269,545, filed on Mar. 18, 2022, which is herein incorporated by reference in its entirety.

### BACKGROUND

### Field of Invention

The present invention relates to nutritional composition and method of preparation thereof. More particularly, the present invention relates to nutritional composition with natural ingredient and method of preparation thereof.

### Description of Related Art

With the improvement of the concept of health, nutritional products containing fats, carbohydrates, and protein are rapidly increasing in the market. However, because raw materials including fats, carbohydrates, and protein are all processed raw materials, they have lost the flavor of the original ingredients, so that the flavor and palatability of nutritional compositions on the market are not good, and are often criticized by consumers.

Although there are also products on the market that increase the flavor of natural ingredients, the same processed raw materials are used such as fruit juice or concentrated puree, so that the final flavor still cannot show the flavor and palatability of natural ingredients.

Therefore, how to add real natural ingredients to prepare a nutritional composition with excellent palatability, the related art really needs to be improved.

### SUMMARY

The present disclosure provides a nutritional composition with natural ingredient, comprising natural ingredient, fat, carbohydrate, and protein, wherein a viscosity of the nutritional composition is from 20 centipoises (cPs) to 1000 cPs.

In some embodiments, the natural ingredient has a weight percentage from 0.1% to 25% based on a total weight (100% by weight) of the nutritional composition.

In some embodiments, the protein has a weight percentage from 0.5% to 20%; the fat has a weight percentage from 0.5% to 20%; and the carbohydrate has a weight percentage from 6% to 40%.

In some embodiments, a count median diameter of the nutritional composition is from 0.2 μm to 500 μm.

In some embodiments, the natural ingredient comprises corn, pumpkin, mushroom, onion, tomato, sesame, nut, or a combination thereof.

In some embodiments, the natural ingredient is corn, and a count median diameter of the nutritional composition is from 1 μm to 500 μm, wherein the natural ingredient has a weight percentage from 0.1% to 25% based on a total weight (100% by weight) of the nutritional composition.

In some embodiments, the natural ingredient is pumpkin, and a count median diameter of the nutritional composition is from 1 μm to 100 μm, wherein the natural ingredient has a weight percentage from 0.4% to 10% based on a total weight (100% by weight) of the nutritional composition.

In some embodiments, the natural ingredient is mushroom, and a count median diameter of the nutritional composition is from 0.5 μm to 60 μm, wherein the natural ingredient has a weight percentage from 0.2% to 10% based on a total weight (100% by weight) of the nutritional composition.

In some embodiments, the nutritional composition is packaged in a sealed container and can be stored stably at room temperature.

In some embodiments, nutritional composition further comprises a preservative, an antioxidant, an emulsifier, a buffer salt, a colorant, a flavoring agent, a thickener, a stabilizer, a quality improver, a spice, a vitamin, a mineral, or a combination thereof.

The present disclosure also provides a method of preparing nutritional composition with natural ingredient, comprising: mixing a natural ingredient and water until uniformly dispersed to obtain a natural ingredient mixed paste; mixing and heating an oil raw material and an emulsifier until uniformly dispersed to obtain an oil mixed paste; mixing a stabilizer and a carbohydrate to obtain a carbohydrate mixed paste, mixing a protein raw material and water until uniformly dispersed to obtain a protein mixed paste, mixing and heating the natural ingredient mixed paste, the oil mixed paste, the carbohydrate mixed paste, and the protein mixed paste, and adjusting pH value to neutral to obtain a nutritional composition; and shearing and stirring the natural ingredient mixed paste, the nutritional composition, or the natural ingredient mixed paste and the nutritional composition in the above steps, so that a count median diameter of the nutritional composition is from 0.2 μm to 500 μm.

In some embodiments, the natural ingredient comprises corn, pumpkin, mushroom, onion, tomato, sesame, nut, or a combination thereof.

In some embodiments, the corn is corn kernels, the pumpkin is pumpkin pulp, the mushroom is mushroom pileus.

In some embodiments, the oil raw material comprises canola oil, sunflower oil, or a combination thereof.

In some embodiments, a temperature of the heating is not higher than a temperature to denature the protein.

In some embodiments, the step of the mixing the stabilizer and the carbohydrate comprises mixing the stabilizer, the carbohydrate, a mineral, and a flavoring agent to obtain the carbohydrate mixed paste.

In some embodiments, the stabilizer comprises carrageenan, gellan gum, or a combination thereof; the carbohydrate comprises rice powder, flour, corn starch, maltodextrin, glucose syrup, corn syrup solid, soy fiber, oat fiber, inulin, fructooligosaccharide, sucrose, or a combination thereof; the mineral comprises calcium carbonate, mineral premix, or a combination thereof; the flavoring agent comprises yeast extract, salt, or a combination thereof.

In some embodiments, the protein raw material comprises casein, whey protein, soy protein, or a combination thereof.

In some embodiments, the method further comprises filling the nutritional composition in a sealed container by high temperature and high pressure sterilization or aseptic filling thereby storing stably at room temperature.

In some embodiments, the step of the shearing and stirring is only shearing and stirring the nutritional composition.

These and other features, aspects, and advantages of the present invention will become better understood with reference to the following description and appended claims.

### DETAILED DESCRIPTION

The following disclosure provides detailed description of many different embodiments, or examples, for implementing different features of the provided subject matter. These are, of course, merely examples and are not intended to limit the invention but to illustrate it. In addition, various embodiments disclosed below may combine or substitute one embodiment with another, and may have additional embodiments in addition to those described below in a beneficial way without further description or explanation. In the following description, many specific details are set forth to provide a more thorough understanding of the present disclosure. It will be apparent, however, to those skilled in the art, that the present disclosure may be practiced without these specific details.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

A number of examples are provided herein to elaborate nutritional composition with natural ingredient and method of preparation thereof of the instant disclosure. However, the examples are for demonstration purpose alone, and the instant disclosure is not limited thereto.

In some embodiments, the present disclosure is related to a nutritional composition with natural ingredient comprising natural ingredient, fat, carbohydrate, and protein, in which a viscosity of the nutritional composition is from 20 cPs to 1000 cPs. The original flavor of the natural ingredients can be retained by adding the natural ingredient and within this viscosity range, and excellent palatability and overall satisfaction can be obtained, such as moderate viscosity, excellent taste and aroma.

As used herein, the terminology “viscosity” has a unit called poise (P) that defines as the dyne force required to move a plane with an area of 1 square centimeter (1 cm²) at a speed of 1 cm per second (1 cm/sec) relative to another parallel plane separated by a fluid with a thickness of 1 cm. For the convenience, the commonly used unit is centipoise (centipoise, cP, i.e. 0.01 P). Furthermore, 1 P is equal to 1 g·s⁻¹·cm⁻¹. According to the International System of Units, the viscosity unit is Pa·s=kg·m⁻¹·s⁻¹, therefore, 1 Pa·s=10 P=1000 cP.

As used herein, the terminology “corn kernels” refers to the fruit of corn, which belongs to caryopsis. The pericarp and seed coat are closely fused and are extremely difficult to separate. Corn kernels are the main edible part.

As used herein, the terminology “pumpkin pulp” refers to the part of the pumpkin that has been peeled and de-seeded.

As used herein, the terminology “mushroom” refers to Agaricus bisporus commonly known as mushrooms.

As used herein, the terminology “pileus” refers to the upper portion of the sporocarp or fruiting body after the stipe is removed.

As used herein, the terminology “stable storage” refers to that after the nutritional composition is stored at room temperature for at least 6 months (including about 6 months to about 24 months and also including about 12 months to about 15 months), the product including nutritional composition can be kept stable, in which the room temperature refers to about 20° C. to about 37° C.

As used herein, the terminology “sterilization” refers to the reduction in transmissible agents such as fungi, bacteria, viruses, spore forms, and so forth, in food or on food grade surfaces to the extent necessary to render such foods suitable for human consumption. Sterilization processes may include various techniques involving the application of heat, peroxide or other chemicals, irradiation, high pressure, filtration, or combinations or variations thereof.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

Main Ingredient of the Nutritional Composition

In some embodiments of the present disclosure, the nutritional composition having nature ingredient includes natural ingredient. The natural ingredient includes at least one that can achieve excellent palatability, and the composition of the nutritional composition is described in detail below.

The natural ingredient referring to the general edible parts of traditional food materials can be edible natural ingredients, such as corn, pumpkin, mushroom, onion, tomato, sesame, nut, or a combination thereof, but is not limited to the examples.

In some embodiments of the present disclosure, the product form of the nutritional composition with natural ingredient is liquid or powder of fat, protein and carbohydrate for oral drinking or tube filling, in which liquid is preferred.

In some embodiments of the present disclosure, the nutritional composition with natural ingredient includes protein, which refers to the protein from animals or plants, can be digested and absorbed by the human body, such as casein, whey protein, soy protein; also includes protein derivatives, such as hydrolyzed whey protein, concentrated whey protein, isolated soy protein, etc.; and has the ability to provide other components of protein nutrition, or a combination thereof, but is not limited to the examples.

In some embodiments of the present disclosure, the nutritional composition with natural ingredient includes fat, which refers to lipid substances processed from animals or plants; also includes synthetic lipid substances, as long as the substance is suitable for human consumption, which can be vegetable oil, animal oil, etc.; and other ingredients that provide fat nutrition, or a combination thereof, but is not limited to the examples.

In some embodiments of the present disclosure, the nutritional composition with natural ingredient includes carbohydrate, which refers to starch or starch derivatives that can provide heat, such as rice powder, flour, corn starch, maltodextrin, glucose syrup, corn syrup solid, soy fiber, oat fiber, inulin, fructooligosaccharide, sucrose, or a combination thereof, but is not limited to examples.

In some embodiments of the present disclosure, the nutritional composition with natural ingredient includes fat, protein, carbohydrate. In general, any sources of fat, protein and carbohydrate known to be suitable for use in nutritional products can be used herein, in which the restriction is that the nutrition of fat, protein, and carbohydrate is compatible with the basic characteristics of the nutritional composition as defined herein.

In some embodiments of the present disclosure, the nutritional composition with natural ingredient calculated as 100% by weight percentage includes: the concentration of protein has a weight percentage from 0.5% to 20% in some examples, 1.5% to 14% in some other examples, 3% to 9% in further examples; the concentration of fat has a weight percentage from 0.5% to 20% in some examples, 1% to 18% in some other examples, 2% to 14% in further examples; the concentration of carbohydrate has a weight percentage from 6% to 40% in some examples, 10% to 28% in some other examples, 13% to 23% in further examples;

The amount of nutritional composition can vary depending on many factors, such as turning a liquid into a powder through an appropriate drying process, spray drying, drum drying, etc. Furthermore, the amount of the nutritional composition also includes when the powder is rehydrated with an appropriate amount of water, the fat, protein, and carbohydrate of the nutritional composition are compatible with the basic elements of the nutritional composition defined herein.

In some embodiments of the present disclosure, the nutritional composition with natural ingredient includes natural ingredient. In some examples, the natural ingredient has a weight percentage from 0.1% to 25%, 0.2% to 15% in some other examples, 0.4% to 10% in further examples.

The Optional Ingredients of Nutritional Composition

The nutritional composition in some embodiments of the present disclosure may further include optional ingredients that may improve the physical, chemical, or stability of the product or other nutritional composition. Many optional ingredients are known to be suitable for use in nutritional products, which also includes those applicable to this nutritional composition, in which the restriction is that the nutrition of the product is compatible with the essential elements of the nutritional composition as defined herein.

Various embodiments of the nutritional composition with a natural ingredient of the present disclosure may also be substantially free of any optional or selected essential components or features described herein, in which the restriction is that the nutritional composition contains all of the essential components or features as described herein. In this context, and unless otherwise specified, the term “substantially free” means that the selected nutritional emulsion contains less than a functional amount of the optional ingredient.

In some embodiment, the nutritional composition optionally choosing other known ingredients includes preservative, antioxidant, emulsifier, buffer salt, colorant, flavoring agent, thickener, stabilizer, quality improver, spice, vitamin, mineral, or a combination thereof, etc.

In some examples, the preservative includes, but is not limited to hexadienoic acids, benzoic acids, anhydrous acetic acids, or a combination thereof.

In some examples, the antioxidant includes, but is not limited to sodium erythorbate, disodium ethylenediaminetetraacetic acid (EDTA-NA2), L-cysteine hydrochloride, vitamin E (tocopherol concentrate), vitamin C (ascorbic acid), or a combination thereof.

In some examples, the emulsifier includes, but is not limited to fatty acid glycerides, fatty acid sorbitol lipids, sodium lactate stearate, or a combination thereof.

In some examples, the buffer salt includes, but is not limited to phosphates, citrates, carbonates, or a combination thereof.

In some examples, the colorant includes, but is not limited to food coloring, caramel coloring, beta carotene, titanium dioxide, red yeast pigment, or a combination thereof.

In some examples, the flavoring agent is divided into sour agent, sweetener, salty agent, and umami agent. The sour agent includes, but is not limited to acetic acid, citric acid, tartaric acid, malic acid, or a combination thereof. The sweetener includes, but is not limited to sucralose, stevioside, mogrosides, glycyrrhizin, saccharin, aspartame, or a combination thereof. The salty agent includes, but is not limited to salt, potassium chloride, or a combination thereof. The umami agent includes, but is not limited to glutamic acid, succinic acid, or a combination thereof.

In some examples, the thickener includes, but is not limited to sodium acrylate, corn sugar gum (sanxian gum), sodium alginate, carrageenan, sodium carboxymethylcellulose, distarch phosphate, distarch hydroxypropyl phosphate, distarch acetylated adipate, cheese vegetarian sodium, guanhua bean gum (guar gum), or a combination thereof.

In some examples, the stabilizer includes, but is not limited to sodium carboxymethylcellulose, carrageenan, gellan gum, locust bean gum, or a combination thereof.

In some examples, the quality improver includes, but is not limited to silicon oxide, phosphates, magnesium carbonate, glycerin, or a combination thereof.

In some examples, the spice is the general term for seasonings made of dried animal tissues or plant seeds, fruits, roots, and bark. Spice includes, but is not limited to basil leaves, rosemary, onion, garlic, chicken spice powder, shiitake mushroom spice powder, garlic extract, hazelnut spice powder, walnut spice powder, mixed stewed meat spice, premium mixed spice, lamb oven spice, papaya powder, strawberry powder, egg milk powder, vanilla spice powder, mint spice, cantaloupe spice, passion fruit spice, chocolate spice, coffee spice, maple syrup spice, taro spice, vanilla milk spice, blueberry spice, grape spice, apple spice, papaya spice, lemon spice, orange spice, egg milk spice, lychee spice, peach spice, mixed fruit spice, mango spice, pineapple spice, honey spice, pudding spice, premium meat spice powder, pork extract, vegetarian carnivorous spice, or a combination thereof.

In some examples, the vitamin includes, but is not limited to vitamin A, choline, vitamin C, vitamin E, calcium pantothenate, vitamin B1, vitamin B6, vitamin B2, folic acid, biotin, vitamin D3, vitamin B12, vitamin K1, taurine, inositol, carotenoids, lutein, salts and derivatives thereof, or a combination thereof. The vitamin premix includes vitamin C, taurine, vitamin E, niacinamide, vitamin A, calcium pantothenate, folic acid, vitamin D3, biotin, vitamin B12, vitamin B6, vitamin K1, vitamin B2, and vitamin B1.

In some examples, the mineral includes, but is not limited to sources of calcium, phosphorus, magnesium, zinc, iron, iodine, selenium, chlorine, potassium, copper, chromium, manganese, molybdenum, or a combination thereof. The mineral premix includes ferrous sulfate, zinc sulfate, manganese sulfate, copper sulfate, chromium trichloride, potassium iodide, sodium molybdate, and sodium selenite.

Preparation Method

The nutritional composition for use herein may be manufactured by any known or otherwise suitable method for making nutritional emulsions, but is not limited to the preparation method in the example.

The method of preparing nutritional composition provides a plurality of mixed pastes, including natural ingredient mixed paste, oil mixed paste, carbohydrate mixed paste, and protein mixed paste.

The natural ingredient mixed paste: natural ingredient and water were provided, and the natural ingredient was put into the water and stirred until uniformly dispersed, depend on different natural ingredient raw material, to obtain the natural ingredient mixed paste. In some examples, the stirring time was 0 hour to 1 hour. In some other examples, the stirring time was 2 minutes to 30 minutes. In further examples, the stirring time was 5 minutes to 15 minutes. Natural ingredients were preprocessed to obtain edible parts, and different ingredients could be prepared by known or otherwise suitable pretreatment methods for the ingredients. In some examples, the preprocessed method included, but is not limited to removing outer leaves, shredding, dicing, and blanching of corn to obtain corn kernels; peeling, deseeding, dicing, and blanching of pumpkin to obtain pumpkin pulp; removing the stipe and blanching the mushroom to obtain mushroom pileus. The preprocessing of ingredients is not limited to the same production site. The purpose of using natural ingredients is to provide nutritional composition with natural ingredient flavor.

The oil mixed paste: oil raw material and emulsifier were provided and mixed and heated until uniformly dispersed to obtain the oil mixed paste. In some examples, oil raw material includes, but is not limited to canola oil and sunflower oil.

The carbohydrate mixed paste: after stabilizer and water were stirred and mixed evenly, carbohydrate, mineral, and flavoring agent were added and stirred evenly at the same time until uniformly dispersed. In some examples, the stirring time was 15 minutes to 30 minutes. In some examples, the stabilizer includes, but is not limited to carrageenan and gellan gum. In some examples, the carbohydrate includes, but is not limited to maltodextrin and sucrose. In some examples, the mineral includes, but is not limited to calcium carbonate and mineral premix. In some examples, the flavoring agent includes, but is not limited to yeast extract and salt. The purpose of using carbohydrate is to provide a balanced carbohydrate source for nutritional composition.

The protein mixed paste: protein raw material and water were provided and stirred at room temperature until uniformly dispersed. In some examples, the stirring time was 2 minutes to 1 hour. In some other examples, the stirring time was 4 minutes to 30 minutes. In further examples, the stirring time was 5 minutes to 15 minutes. The protein raw material includes, but is not limited to calcium caseinate and sodium caseinate. The purpose of adding protein is to provide a balanced source of protein for nutritional composition.

The oil mixed paste, the carbohydrate mixed paste, the protein mixed paste, and the natural ingredient mixed paste were mixed and heated, and then pH value was adjusted to neutral to obtain a nutritional composition. In some examples, the oil mixed paste, the carbohydrate mixed paste, the protein mixed paste, and the natural ingredient mixed paste could be mixed at the same time, or mixed in any order, such as the oil mixed paste and the natural ingredient mixed paste were mixed first, and then mixed with the carbohydrate mixed paste and the protein mixed paste. In some examples, when the oil mixed paste was mixed with any other mixed paste, it needs to be heated at the same time to achieve homogeneity and emulsification properties. In some examples, the heating temperature was not higher than a temperature to denature the protein, for examples, the heating temperature should not be higher than 75° C. to avoid protein nutrient loss. In some examples, pH value was adjusted to neutral ranging from pH 5.5 to pH 8.5.

The natural ingredient mixed paste, the nutritional composition, or the natural ingredient mixed paste and the nutritional composition in the above steps was sheared and stirred, so that the count median diameter (D50) of the nutritional composition was from 0.2 μm to 500 μm. In some examples, shearing and stirring at the step of complete natural ingredient mixed paste, shearing and stirring the steps of complete natural ingredient mixed paste and the final nutritional composition, or only shearing and stirring the final nutritional composition could be chosen, as long as the particle size (count median diameter) of the natural ingredient ranging from 0.2 μm to 500 μm was achieved. In some examples, the count median diameter ranging from 0.2 μm to 500 μm could obtain great palatability, such as moderate viscosity, excellent taste, and aroma flavor. In some other examples, the count median diameter was from 0.4 μm to 150 μm. In further examples, the count median diameter was from 0.6 μm to 80 μm. In some examples, shearing and stirring was processed by high-speed shearing equipment. The shearing and stirring was processed, but was not limited to after all of the mixed pastes had been mixed, only with the natural ingredient mixed paste, or after the natural ingredient mixed paste and any one or more of the mixed pastes had been mixed.

The nutritional composition was filled in the sealed container by high temperature and high pressure sterilization or aseptic filling thereby storing stably at room temperature. In some examples, the room temperature was about 20° C. to 37° C.

The manufacturing processes for the nutritional composition may be carried out in ways other than those set forth herein without departing from the spirit and scope of the present invention. The present embodiments are, therefore, to be considered in all respects illustrative and not restrictive and that all changes and equivalents also come within the description of the present disclosure.

### EXAMPLE

The examples mentioned below were composed similarly and prepared by the aforementioned method, each example was nutritional composition including protein, fat, carbohydrate, vitamin, mineral, and flavoring agent, and includes different types and different amounts of natural ingredient. The count median diameter and viscosity characteristics of nutritional composition were tested, and samples were evaluated by using standard sensory evaluation methods (5 point scale).

The natural ingredient aroma preference and taste preference were evaluated on a 5 point scale, the higher the score, the greater the preference, and the preference was acceptable if the score was above 3. Palatability preference (also called overall satisfaction) expressed on a 5 point scale dividing into very satisfied, satisfied, average, dissatisfied, and very dissatisfied, a total of 5 points. The percentage of the number of judges who chose very satisfied and satisfied was calculated, being the palatability preference. The higher the percentage, the higher the satisfaction. The preference over ½ (50%) is acceptable, and the preference less than 50% is unacceptable.

The nutritional composition examples and features is described below, with reference to the following examples, which are provided for illustrative purposes only and should not be understood as limiting the present invention, because many changes can be made thereof without departing from the spirit and scope of the present invention.

Please refer to Table 1. Theoretically, aroma preference of the natural ingredient should increase as the content of the natural ingredient increases. However, the aroma preference and taste preference of the natural ingredient did not increase with the content of natural ingredient (corn) according to examples 1 to 8. Please refer to example 1 and comparative example 1 at the same time, example 1 indicated that when the content of the natural ingredient (corn) was 25% by weight, the count median diameter was 371 μm and the viscosity was 758 cPs. Thus, it maintained a good aroma and taste, and the overall palatability preference was 50%. On the contrary, comparative example 1 with the same weight percentage of the example 1 indicated that when the content of the natural ingredient (corn) was 25% by weight, the viscosity exceeded 1000 cPs was too viscous, resulting in affecting the suffusion (or performance) of aroma and the poor taste. In the end, the palatability preference lower than 50% was not good, and the comparative example 1 was to be excluded.

Please refer to example 6 and comparative example 2 at the same time, example 6 indicated that when the content of the natural ingredient (corn) was 3% by weight, the count median diameter was 15 μm and the viscosity was 72 cPs. Thus, it maintained a good aroma and taste, and the overall palatability preference was 50%. On the contrary, the same comparative example 2 with the same weight percentage indicated that although the content of the natural ingredient (corn) was not the lowest, the count median diameter was 0.484 μm. The flavor presented by the sample was no longer the original flavor of the natural ingredient, having changed into an emulsified milk flavor. The viscosity of the sample was low, lacking of thick taste. Therefore, the aroma and the taste preference of natural ingredient were not good, and the comparative example 2 was to be excluded.

Example 8 indicated that the content of the natural ingredient (corn) was 0.1% by weight, taste was acceptable because the count median diameter was still in the appropriate range. However, the natural ingredient aroma did not suffuse because of low content, so the natural ingredient aroma suffusion (or preference) was not good (less than 3 points).

Please refer to example 4 and example 4-1 at the same time, the difference of example 4 and example 4-1 is that the nutritional composition in example 4 was sheared and stirred at the end of the preparation, while example 4-1 processed shearing and stirring for natural ingredient mixed paste when preparing natural ingredient mixed paste, but did not process shearing and stirring for the nutritional composition during the end of the preparation. The example 4 indicated that when natural ingredient (corn) was 9% by weight, the count median diameter was 6.46 μm and the viscosity is 100 cPs. Thus, it maintained excellent aroma and taste, and the overall palatability preference was 85%. Example 4-1 disclosed that the natural ingredient mixed paste was sheared and stirred singly, and then evenly mixed with other mixed pastes. When the weight percentage of the natural ingredient (corn, 9% by weight) and the count median diameter (5.36 μm) in example 4-1 were similar to that of example 4, flavor and viscosity could also be extremely similar, and overall palatability preference was also 85%.

TABLE 1
ingredient

| (% by | comparative | | | | | | | | | | example | | | | comparative | | | | | | | |
|---|---|---|---|---|---|---|---|---|---|---|---|---|---|---|---|---|---|---|---|---|---|---|
| weight) | example 1 | | example 1 | | example 2 | | example 3 | | example 4 | | 4-1* | | example 5 | | example 2 | | example 6 | | example 7 | | example 8 | |
| water | filling | | filling | | filling | | filling | | filling | | filling | | filling | | filling | | filling | | filling | | filling | |
| | to 100 | | to 100 | | to 100 | | to 100 | | to 100 | | to 100 | | to 100 | | to 100 | | to 100 | | to 100 | | to 100 | |
| corn | 25 | | 25 | | 22 | | 15 | | 9 | | 9 | | 9 | | 3 | | 3 | | 1 | | 0.1 | |
| canola oil | 3 | | 3 | | 3 | | 3 | | 3 | | 3 | | 3 | | 3 | | 3 | | 3 | | 3 | |
| emulsifier | 0.5 | | 0.5 | | 0.5 | | 0.5 | | 0.5 | | 0.5 | | 0.5 | | 0.5 | | 0.5 | | 0.5 | | 0.5 | |
| malto- | 13 | | 13 | | 13 | | 13 | | 13 | | 13 | | 13 | | 13 | | 13 | | 13 | | 13 | |
| dextrin | | | | | | | | | | | | | | | | | | | | | | |
| sucrose | 0.5 | | 0.5 | | 0.5 | | 0.5 | | 0.5 | | 0.5 | | 0.5 | | 0.5 | | 0.5 | | 0.5 | | 0.5 | |
| calcium | 0.2 | | 0.2 | | 0.2 | | 0.2 | | 0.2 | | 0.2 | | 0.2 | | 0.2 | | 0.2 | | 0.2 | | 0.2 | |
| carbonate | | | | | | | | | | | | | | | | | | | | | | |
| salt | 0.3 | | 0.3 | | 0.3 | | 0.3 | | 0.3 | | 0.3 | | 0.3 | | 0.3 | | 0.3 | | 0.3 | | 0.3 | |
| yeast | 0.5 | | 0.5 | | 0.5 | | 0.5 | | 0.5 | | 0.5 | | 0.5 | | 0.5 | | 0.5 | | 0.5 | | 0.5 | |
| extract | | | | | | | | | | | | | | | | | | | | | | |
| mineral | 0.5 | | 0.5 | | 0.5 | | 0.5 | | 0.5 | | 0.5 | | 0.5 | | 0.5 | | 0.5 | | 0.5 | | 0.5 | |
| premix | | | | | | | | | | | | | | | | | | | | | | |
| vitamin | 0.05 | | 0.05 | | 0.05 | | 0.05 | | 0.05 | | 0.05 | | 0.05 | | 0.05 | | 0.05 | | 0.05 | | 0.05 | |
| premix | | | | | | | | | | | | | | | | | | | | | | |
| carra- | 0.03 | | 0.03 | | 0.03 | | 0.03 | | 0.03 | | 0.03 | | 0.03 | | 0.03 | | 0.03 | | 0.03 | | 0.03 | |
| geenan | | | | | | | | | | | | | | | | | | | | | | |
| calcium | 2.5 | | 2.5 | | 2.5 | | 2.5 | | 2.5 | | 2.5 | | 2.5 | | 2.5 | | 2.5 | | 2.5 | | 2.5 | |
| caseinate | | | | | | | | | | | | | | | | | | | | | | |
| sodium | 1.5 | | 1.5 | | 1.5 | | 1.5 | | 1.5 | | 1.5 | | 1.5 | | 1.5 | | 1.5 | | 1.5 | | 1.5 | |
| caseinate | | | | | | | | | | | | | | | | | | | | | | |
| features | | | | | | | | | | | | | | | | | | | | | | |
| D50 | 622 | μm | 371 | μm | 154 | μm | 297 | μm | 6.46 | μm | 5.36 | μm | 84.9 | μm | 0.484 | μm | 15.0 | μm | 1.37 | μm | 8.16 | μm |
| viscosity | 1320 | cPs | 758 | cPs | 356 | cPs | 624 | cPs | 100 | cPs | 88 | cPs | 280 | cPs | 16 | cPs | 72 | cPs | 48 | cPs | 64 | cPs |

| | | | | | | | | | | | |
|---|---|---|---|---|---|---|---|---|---|---|---|
| natural | 2.8 | 3.1 | 3.6 | 3.0 | 4.0 | 4.0 | 3.7 | 2.9 | 3.6 | 3.5 | 2.9 |
| ingredient | | | | | | | | | | | |
| aroma | | | | | | | | | | | |
| preference | | | | | | | | | | | |
| taste | 1.8 | 2.7 | 3.3 | 2.9 | 4.0 | 3.9 | 3.6 | 2.5 | 3.8 | 3.7 | 3.5 |
| preference | | | | | | | | | | | |
| palat- | 33% | 50% | 74% | 51% | 85% | 85% | 79% | 48% | 75% | 71% | 52% |
| ability | | | | | | | | | | | |
| preference | | | | | | | | | | | |

*example 4-1 was sheared and stirred singly, and then evenly mixed with other mixed pastes. The nutritional compositions in other examples and comparative examples were only sheared and stirred at the end of the preparation process (Table 2 and Table 3 are also the same).

Please refer to Table 2 below. The compositions in examples 9 to 12 and comparative example 3 were similar and were prepared by the above mentioned preparation method. Each one of the examples was nutritional composition including protein, fat, carbohydrate, vitamin, mineral, and flavoring agent, in which the content of the natural ingredient (pumpkin) were different. The count median diameter and viscosity characteristics of nutritional composition were tested, and samples were evaluated by using standard sensory evaluation methods (5 point scale).

Examples 9 to 12 indicated different result than corn, the higher the content of natural ingredient (pumpkin) and the lower the count median diameter, the higher trend of the viscosity.

Comparing to example 10, comparative example 3 indicated that the content of natural ingredient (pumpkin) was the same (10% by weight) with example 10, but because of the low count median diameter (1.05 μm), the viscosity exceeded 1000 cPs was too viscous, resulting in affecting the suffusion (or performance) of aroma and the poor taste.

TABLE 2

| ingredient | | | comparative | | | | | | | |
|---|---|---|---|---|---|---|---|---|---|---|
| (% by weight) | example 9 | | example 3 | | example 10 | | example 11 | | example 12 | |
| water | filling to 100 | | filling to 100 | | filling to 100 | | filling to 100 | | filling to 100 | |
| pumpkin | 10 | | 10 | | 5 | | 5 | | 0.4 | |
| sunflower oil | 5 | | 5 | | 5 | | 5 | | 5 | |
| emulsifier | 0.6 | | 0.6 | | 0.6 | | 0.6 | | 0.6 | |
| maltodextrin | 13 | | 13 | | 13 | | 13 | | 13 | |
| indigestible | 6 | | 6 | | 6 | | 6 | | 6 | |
| maltodextrin | | | | | | | | | | |
| sucrose | 0.5 | | 0.5 | | 0.5 | | 0.5 | | 0.5 | |
| calcium carbonate | 0.2 | | 0.2 | | 0.2 | | 0.2 | | 0.2 | |
| salt | 0.5 | | 0.5 | | 0.5 | | 0.5 | | 0.5 | |
| yeast extract | 0.5 | | 0.5 | | 0.5 | | 0.5 | | 0.5 | |
| mineral premix | 0.5 | | 0.5 | | 0.5 | | 0.5 | | 0.5 | |
| vitamin premix | 0.05 | | 0.05 | | 0.05 | | 0.05 | | 0.05 | |
| carrageenan | 0.03 | | 0.03 | | 0.03 | | 0.03 | | 0.03 | |
| calcium caseinate | 3.5 | | 3.5 | | 3.5 | | 3.5 | | 3.5 | |
| sodium caseinate | 2.5 | | 2.5 | | 2.5 | | 2.5 | | 2.5 | |
| features | | | | | | | | | | |
| count median | 95.5 | μm | 1.05 | μm | 76.0 | μm | 2.20 | μm | 60.0 | μm |
| diameterD50 | | | | | | | | | | |
| viscosity | 320 | cPs | 1080 | cPs | 148 | cPs | 960 | cPs | 116 | cPs |

| | | | | | |
|---|---|---|---|---|---|
| natural ingredient | 3.9 | 2.6 | 4.0 | 3.3 | 3.4 |
| aroma preference | | | | | |
| taste preference | 3.4 | 2.1 | 4.1 | 3.0 | 3.8 |
| palatability | 80% | 42% | 88% | 52% | 80% |
| preference | | | | | |

Please refer to Table 3 below. The compositions in examples 14 to 16 were similar and were prepared by the above mentioned preparation method. Each one of the examples was nutritional composition including protein, fat, carbohydrate, vitamin, mineral, and flavoring agent, in which the content of the natural ingredient (mushroom) were different. The count median diameter and viscosity characteristics of nutritional composition were tested, and samples were evaluated by using standard sensory evaluation methods (5 point scale).

Examples 13 to 15 indicated different result than corn and pumpkin, in which the content of the natural ingredient (mushroom) and the count median diameter did not affect the viscosity. In example 14, because the count median diameter was lower (0.76 μm) and the viscosity was moderate, the suffusion (or performance) of the mushroom aroma were more obviously. Therefore, the natural ingredient aroma and the taste preference were great, and the overall palatability preference was up to 91%.

TABLE 3

| ingredient | | | | | | |
|---|---|---|---|---|---|---|
| (% by weight) | example 13 | | example 14 | | example 15 | |
| water | filling to 100 | | filling to 100 | | filling to 100 | |
| mushroom | 9 | | 4 | | 0.2 | |
| canola oil | 3 | | 3 | | 3 | |
| sunflower oil | 3 | | 3 | | 3 | |
| emulsifier | 0.7 | | 0.7 | | 0.7 | |
| maltodextrin | 18 | | 18 | | 18 | |
| sucrose | 0.5 | | 0.5 | | 0.5 | |
| calcium carbonate | 0.2 | | 0.2 | | 0.2 | |
| salt | 0.5 | | 0.5 | | 0.5 | |
| yeast extract | 0.5 | | 0.5 | | 0.5 | |
| mineral premix | 0.5 | | 0.5 | | 0.5 | |
| vitamin premix | 0.05 | | 0.05 | | 0.05 | |
| carrageenan | 0.03 | | 0.03 | | 0.03 | |
| calcium caseinate | 3.5 | | 3.5 | | 3.5 | |
| sodium caseinate | 2.5 | | 2.5 | | 2.5 | |
| features | | | | | | |
| count median | 58.3 | μm | 0.762 | μm | 1.37 | μm |
| diameter D50 | | | | | | |
| viscosity | 96 | cPs | 88 | cPs | 72 | cPs |

| | | | |
|---|---|---|---|
| natural ingredient | 3.4 | 3.8 | 3.6 |
| aroma preference | | | |
| taste preference | 3.5 | 3.8 | 3.7 |
| palatability | 79% | 91% | 82% |
| preference | | | |

In some embodiment, the present disclosure provides a nutritional composition with natural ingredient including natural ingredient, fat, carbohydrate, and protein, in which the nutritional composition includes viscosity from 20 cPs to 1000 cPs. The original flavor of the natural ingredients can be retained by adding the natural ingredient and within this viscosity range, and excellent palatability and overall satisfaction can be obtained, such as moderate viscosity, excellent taste and aroma.

In some embodiments of the present disclosure, when the natural ingredient is less than 0.1% by weight, the flavor of natural ingredient in the prepared nutritional composition does not show. The viscosity of the nutritional composition is higher than 1000 cPs, thereby high viscosity and poor palatability preference. In addition, the aforementioned nutritional composition containing more than about 0.1% by weight and less than 25% by weight of natural ingredient is prone to precipitation while the count median diameter is higher than 500 μm after high-speed shearing, and the viscosity is relatively high and the palatability is not good. And when the count median diameter D50 after high-speed shearing is less than 0.2 μm, although the nutritional composition has moderate viscosity, the natural ingredient flavor becomes weaker because the flavor of the nutritional composition transforms into emulsified milk flavor and the palatability is not good.

While the disclosure has been described by way of example(s) and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A nutritional composition with natural ingredient, comprising natural ingredient, fat, carbohydrate, and protein, wherein a viscosity of the nutritional composition is from 20 centipoises (cPs) to 1000 cPs.

2. The nutritional composition of claim 1, wherein the natural ingredient has a weight percentage from 0.1% to 25% based on a total weight (100% by weight) of the nutritional composition.

3. The nutritional composition of claim 2, wherein
the protein has a weight percentage from 0.5% to 20%;
the fat has a weight percentage from 0.5% to 20%; and
the carbohydrate has a weight percentage from 6% to 40%.

4. The nutritional composition of claim 1, wherein a count median diameter of the nutritional composition is from 0.2 μm to 500 μm.

5. The nutritional composition of claim 1, wherein the natural ingredient comprises corn, pumpkin, mushroom, onion, tomato, sesame, nut, or a combination thereof.

6. The nutritional composition of claim 5, wherein the natural ingredient is corn, and a count median diameter of the nutritional composition is from 1 μm to 500 μm, wherein the natural ingredient has a weight percentage from 0.1% to 25% based on a total weight (100% by weight) of the nutritional composition.

7. The nutritional composition of claim 5, wherein the natural ingredient is pumpkin, and a count median diameter of the nutritional composition is from 1 μm to 100 μm, wherein the natural ingredient has a weight percentage from 0.4% to 10% based on a total weight (100% by weight) of the nutritional composition.

8. The nutritional composition of claim 5, wherein the natural ingredient is mushroom, and a count median diameter of the nutritional composition is from 0.5 μm to 60 μm, wherein the natural ingredient has a weight percentage from 0.2% to 10% based on a total weight (100% by weight) of the nutritional composition.

9. The nutritional composition of claim 1, wherein the nutritional composition is packaged in a sealed container and can be stored stably at room temperature.

10. The nutritional composition of claim 1, further comprising a preservative, an antioxidant, an emulsifier, a buffer salt, a colorant, a flavoring agent, a thickener, a stabilizer, a quality improver, a spice, a vitamin, a mineral, or a combination thereof.

11. A method of preparing nutritional composition with natural ingredient, comprising:
mixing a natural ingredient and water until uniformly dispersed to obtain a natural ingredient mixed paste;
mixing and heating an oil raw material and an emulsifier until uniformly dispersed to obtain an oil mixed paste;
mixing a stabilizer and a carbohydrate to obtain a carbohydrate mixed paste,
mixing a protein raw material and water until uniformly dispersed to obtain a protein mixed paste,
mixing and heating the natural ingredient mixed paste, the oil mixed paste, the carbohydrate mixed paste, and the protein mixed paste, and adjusting pH value to neutral to obtain a nutritional composition; and
shearing and stirring the natural ingredient mixed paste, the nutritional composition, or the natural ingredient mixed paste and the nutritional composition in the above steps, so that a count median diameter of the nutritional composition is from 0.2 μm to 500 μm.

12. The method of claim 11, wherein the natural ingredient comprises corn, pumpkin, mushroom, onion, tomato, sesame, nut, or a combination thereof.

13. The method of claim 12, wherein the corn is corn kernels, the pumpkin is pumpkin pulp, the mushroom is mushroom pileus.

14. The method of claim 11, wherein the oil raw material comprises canola oil, sunflower oil, or a combination thereof.

15. The method of claim 11, wherein a temperature of the heating is not higher than a temperature to denature the protein.

16. The method of claim 11, wherein the step of the mixing the stabilizer and the carbohydrate comprises mixing the stabilizer, the carbohydrate, a mineral, and a flavoring agent to obtain the carbohydrate mixed paste.

17. The method of claim 16, wherein
the stabilizer comprises carrageenan, gellan gum, or a combination thereof,
the carbohydrate comprises rice powder, flour, corn starch, maltodextrin, glucose syrup, corn syrup solid, soy fiber, oat fiber, inulin, fructooligosaccharide, sucrose, or a combination thereof;
the mineral comprises calcium carbonate, mineral premix, or a combination thereof;
the flavoring agent comprises yeast extract, salt, or a combination thereof.

18. The method of claim 11, wherein the protein raw material comprises casein, whey protein, soy protein, or a combination thereof.

19. The method of claim 11, further comprising filling the nutritional composition in a sealed container by high temperature and high pressure sterilization or aseptic filling thereby storing stably at room temperature.

20. The method of claim 11, wherein the step of the shearing and stirring is only shearing and stirring the nutritional composition.
